(19) United States
(12) Patent Application Publication
(10) Pub. No.: US 2003/0164683 A1
(43) Pub. Date: Sep. 4, 2003

(54) Decoration lamp bulb for Christmas

(76) Inventor: Hung-Huei Cheng, Taipei (TW)

Correspondence Address: BUCKNAM AND ARCHER, 1077 Northern Boulevard, Roslyn, NY, 11576-1696, US

(21) Appl. No.: 10/287,890

(22) Filed: Nov. 5, 2002

(30) Foreign Application Priority Data
Mar. 1, 2002 (CN) 02206698.5

(51) Int. Cl. H01K 1/26

(52) U.S. Cl. 313/580

(57) ABSTRACT

A decoration lamp bulb for Christmas use comprises a lamp bulb body in which a tungsten filament lampwick is mounted within the lamp bulb body, and two poles connecting legs being drawn out from two ends of tungsten filament lampwick, and a vacuum sealing state being maintained within the lamp bulb body by a primary evacuating operation; a outer enclosure within which said lamp bulb body is packaged, and two-poles connecting legs extended from said bulb body, and a vacuum state being maintained within the outer enclosure by a secondary evacuating operation. Thus, the vacuum layer of the outer enclosure can segregate the heat conduction from the tungsten filament lamp surface. Therefore, the brightness can be made higher by the raising of electric current value with better safety and longer service life.

### FIELD OF THE INVENTION

This invention relates to a novel structure of decoration lamp bulb for Christmas use, particularly to a complex vacuum enclosure type decoration lamp bulb for Christmas use, wherein the heat conduction from the tungsten filament lamp surface can be segregated by the vacuum layer of the outer enclosure. Therefore, the brightness can be made higher by the raising of electric current value with better safety and longer service life.

### BACKGROUND OF THIS INVENTION

As shown in FIG. 1, a conventional decoration lamp bulb for Christmas use comprises a lamp bulb body 10 in which a tungsten filament lampwick 11 is mounted within the lamp bulb body 10, and two poles connecting legs 12, 12′ being drawn out from two ends of tungsten filament lampwick 11, and a hot bead 13 being used for the separation of the two poles connecting legs 12, 12′, then a vacuum sealing state being maintained within the lamp bulb body 10 by a evacuating process. Thus, the tungsten filament lampwick 11 can generate high heat so as to illuminate incandescent lamp.

After the electric current flowing into the conventional decoration lamp bulb 1 for Christmas use, heat generated due to the high temperature caused by the current flowing into tungsten filament lampwick 11 will conduct to the surface of lamp bulb 10 according to the way described below.

1. convection: Few gas is still remaining within the lamp body 10 even after the evacuation process. The high temperature generated on the tungsten filament lampwick 11 by the current flowing into the lamp bulb 1 can facilitate the convection of the small amount of gas. Thereby, heat can be convected to the glass enclosure of the lamp bulb 10.

2. radiation: The heat, which is caused by the high temperature generated on the tungsten filament lampwick 11 by the current flowing into the lamp bulb 1, can be radiated directly by light to the glass enclosure of the lamp bulb body 10.

As described above, the high temperature on the bulb surface is not only liable to cause danger, particularly in the area adjacent to flammable or plastic materials or the place easily accessible by children, but also will make the service life worsened. Therefore, conventional Christmas decoration lamp bulb 1 uses low current value in its circuit, e.g., 0.1, 0.15, 0.2 Ampere etc. as a measure to reduce the risk. However, the brightness is also reduced thereby. In addition, the lamp bulb 1 is often coated on its inside or outside surface with a variety of color to display colorful light. However, if the color is coated on its inside surface, the volatile materials will negatively affect the service life of light bulb 1, if on its outside surface, fading and color striping will occur.

In addition, conventional Christmas decoration lamp string circuit 3 as shown in FIG. 2 is formed by a plurality of lamp string unit 2 parallelly connected together, and each lamp string unit 2 is formed by a plurality of decoration lamp bulb 1 serially linked together. Accordingly, if tungsten filament lampwick of anyone of bulb 1 is burned down, the circuit of the whole lamp string unit 2 will be opened so that the other bulbs 1 of the same lamp string unit 2 will not light.

### SUMMARY OF THE INVENTION

The main object of this invention is to provide a Christmas decoration lamp bulb which prevents the heat generated due to the high temperature of tungsten filament lampwick from conducting to the lamp enclosure surface of light bulb. To achieve the abovementioned and the other objects, this invention comprises a lamp bulb body in which a tungsten filament lampwick is mounted within the lamp bulb body, and two-poles connecting legs being drawn out from two ends of tungsten filament lampwick, and a vacuum sealing status being maintained within the lamp bulb body by a primary evacuating operation; an outer enclosure within which said lamp bulb body is packaged, and two-poles connecting legs extended from said bulb body, and a vacuum state being maintained within the outer enclosure by a secondary evacuating operation. Thus, the vacuum layer of the outer enclosure body can segregate the heat conduction from the tungsten filament lamp surface. Therefore, the brightness can be made higher by the raising of electric current value with better safety and longer service life.

Another object of this invention is to provide a diversified and colorful Christmas decoration lamp bulb. According to this invention, the outer enclosure of light bulb can be formed into any shape so as to display its colorful varieties. Furthermore, the inner layer surface of light bulb can be coated with any color, and then closed by the outer closure with the segregation of a vacuum layer. Thus, the service life of the light bulb will not be negatively influenced and the risk of fading can be prevented.

Further object of this invention is to provide a Christmas decoration lamp in which the burning down of tungsten filament lampwick of any one of bulbs will not cause the other bulbs of the same lamp string unit becoming opened. According to this invention, a bypass fuse is surrounding between the two poles connecting legs of bulb. In normal cases, two poles connecting legs are strained by the tungsten filament lampwick, while the bypass fuse being loosely surrounding the two-poles connecting legs, so that most of the electric current flows through the tungsten filament lampwick, only few current flowing through fuse. In case of burning down of the tungsten filament lampwick, the ends of two-poles connecting legs is released and springing outwardly, while the bypass fuse being still connecting to form a closed circuit. Thus, the other bulbs can still maintain the lighting state through the closed circuit serially connecting with the bypass fuse at the time of burning down of tungsten filament lampwick of any one of bulbs.

### BRIEF DESCRIPTION OF THE DRAWINGS

The above-mentioned objects, features and functions of this invention will become more apparent by the description of an embodiment of present invention with reference to the accompanied drawings, in which:

FIG. 1 is a schematic view showing the structure of a conventional Christmas decoration lamp;

FIG. 2 is a schematic view showing the circuit of a conventional Christmas decoration lamp;

FIG. 3 is a schematic view of an embodiment of Christmas decoration lamp of present invention;

FIG. 4 is a schematic view of 2nd embodiment of Christmas decoration lamp of present invention;

FIG. 5 is a schematic view of 3rd embodiment of Christmas decoration lamp of present invention.

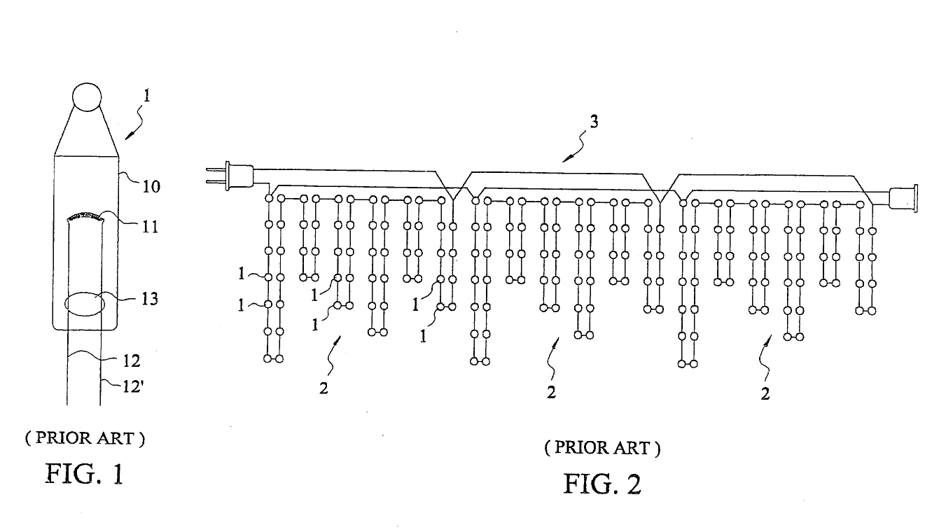

### DETAILED DESCRIPTION OF THE PREFERRED EMBODIMENT OF THE INVENTION

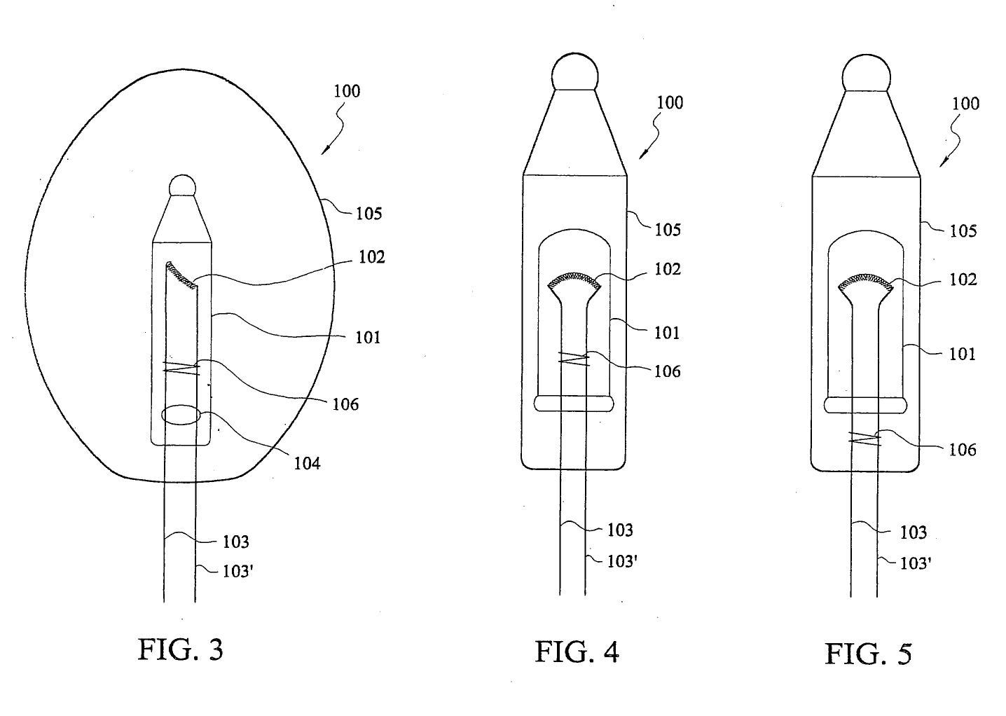

Firstly referring to FIG. 3, the basic structure of a Christmas decoration lamp bulb 100 of this invention, similar to conventional structure, has a lamp bulb body 101 in which a tungsten filament lampwick 102 is mounted within the lamp bulb body 101, and two-poles connecting legs 103,103′ being drawn out from two ends of tungsten filament lampwick 102, said two-poles connecting legs 103,103′ being separated by a hot bead 104, and a vacuum sealing state being maintained within the lamp bulb body 101 by a primary evacuating operation.

However, the Christmas decoration lamp bulb 100 of present invention, different from the conventional structure, has an outer enclosure 105 within which said lamp bulb body 101 is packaged, and two-poles connecting legs 103,103′ extended from said bulb body 101, and a vacuum state being maintained within the outer enclosure body 105 by a secondary evacuating operation. Thus, the heat conduction from the surface of lamp bulb body 101 can be segregated by the vacuum layer of the outer enclosure 105. Therefore, better safety and longer service life can be obtained. The brightness can be made higher by the raising of electric current value.

Present invention is additionally having a bypass fuse 106 surrounding between the two-poles connecting legs 103,103′ of the lamp bulb body 101. In normal cases, the ends of the two-poles connecting legs 103,103′ are strained by the tungsten filament lampwick 102, while the bypass fuse 106 being loosely surrounding the two-poles connecting legs 103,103′, so that most of the electric current flows through the tungsten filament lampwick 102, only few current flowing through fuse 106. In case of burning down of the tungsten filament lampwick 102, the ends of two poles connecting legs 103,103′ is released and springing outwardly, while the bypass fuse 106 being still connecting to form a closed circuit. Thus, the other bulbs can still maintain the lighting state through the closed circuit serially connecting with the bypass fuse 106 at the time of burning down of tungsten filament lampwick of any one of bulbs.

FIG. 4 shows another embodiment of present invention. The basic structure of the Christmas decoration lamp bulb 100 of this embodiment is the same as aforementioned embodiment. Therefore, detailed description is omitted for clarity. The outer enclosure of said Christmas decoration lamp bulb 100 can be formed into any shape, and the inner layer surface of light bulb body 101 can be coated with any color so as to display its colorful varieties. Furthermore, the light bulb body 101 is closed by the outer closure 105 with the segregation of a vacuum layer. Thus, the risk of fading and color striping can be prevented.

FIG. 5 shows another embodiment of present invention. In this embodiment, the bypass fuse 106 of the decoration lamp bulb 100 is of outside-provision type, and is provided on the two-poles connecting legs 103,103′ between the outer enclosure 105 and lamp bulb body 101 by vacuum forming process. Alternatively, the bypass fuse 106 of the decoration lamp bulb 100 can also be provided, similarly to the inside-provision type of former embodiment, on the two-poles connecting legs 103,103′ inside the lamp bulb body 101 by vacuum forming process.

Based on the foregoing description, the heat conduction of the surface of lamp bulb with tungsten filament can be segregated effectively by the vacuum layer of the outer enclosure of the Christmas decoration lamp of present invention. Thus, the brightness can be made higher by the raising of electric current value with better safety and longer service life and variety profile. Accordingly, this Christmas decoration lamp can be recognized as novel invention with inventive step and with industrial availability.

The above embodiments of present invention are preferred embodiments for illustrative use, not limitation for present invention. It is apparent to those who are skilled in this art, any equivalent modification and variation is considered to be within the scope of this invention without departing from the spirit and scope defined by the claims of present invention.

### SYMBOL LIST OF PART REFERENCE

100 Christmas decoration lamp bulb

101 lamp bulb body

102 tungsten filament lampwick

103,103′ two-poles connecting legs

104 hot bead

105 outer enclosure

106 bypass fuse

1. A decoration lamp bulb for Christmas use, comprising
a lamp bulb body in which a tungsten filament lampwick is mounted within the lamp bulb body, and two-poles connecting legs being drawn out from two ends of tungsten filament lampwick, and a vacuum sealing state being maintained within the lamp bulb body by a primary evacuating operation, characterized in that:
said lamp bulb having an outer enclosure within which said lamp bulb body is packaged, and two poles connecting legs extended from said bulb body, and a vacuum state being maintained within the outer enclosure by a secondary evacuating operation.

2. A decoration lamp bulb for Christmas use as claimed in claim 1, wherein a bypass fuse is surrounding between said two two-poles connecting legs.

3. A decoration lamp bulb for Christmas use as claimed in claim 2, wherein said bypass fuse is provided within said bulb body.

4. A decoration lamp bulb for Christmas use as claimed in claim 2, wherein said bypass fuse is provided between outer enclosure and said bulb body.

5. A decoration lamp bulb for Christmas use as claimed in claim 1, wherein said outer enclosure can formed into any shape.

6. A decoration lamp bulb for Christmas use as claimed in claim 1, wherein the inner layer surface of bulb can be coated with any color.
